(19) United States
(12) Patent Application Publication
(10) Pub. No.: US 2021/0001802 A1
(43) Pub. Date: Jan. 7, 2021

(54) EXTERNAL SEAT BELT NOTIFICATION

(71) Applicant: Frank Petrola, Wintersville, OH (US)

(72) Inventor: Frank Petrola, Wintersville, OH (US)

(21) Appl. No.: 16/502,801

(22) Filed: Jul. 3, 2019

(51) Int. Cl. B60R 22/48; B60Q 1/50

(52) U.S. Cl. CPC B60R 22/48; B60R 2022/1806; B60R 2022/4875; B60Q 1/50

(57) ABSTRACT

An illustrated view of a vehicle with an exemplary system for providing external notification of seat belt status. The external system is useful for vehicles relating a condition of the seat belt to public safety officials such as police, state troopers, etc. With the external status being visible, the safety of all who are on the road and in the vehicle is enhanced. The external status allows public safety officials to have visible notification to the seat belt status and provides probable cause to remedy the situation. The vehicle has one or more seat belts configured to have a sensor. The sensor detects the condition of the seat belts. The sensor sends the detected condition to one or more exterior seat belt lights configured on the front and back of the vehicle to notify public safety officials of the seat belt status.

### FIELD OF THE INVENTION

This invention relates to seat belt. More particularly, it relates to notification of seat belt status.

### BACKGROUND

A seat belt (also known as a seatbelt or safety belt) is a vehicle safety device designed to secure the occupant of a vehicle against harmful movement that may result during a collision or a sudden stop. A seat belt functions to reduce the likelihood of death or serious injury in a traffic collision by reducing the force of impacts with interior strike hazards, by keeping occupants positioned correctly for maximum effectiveness of the airbag (if equipped) and by preventing occupants being ejected from the vehicle in a crash or if the vehicle rolls over.

When in motion, the driver and passengers are travelling at the same speed as the car. If the driver makes the car suddenly stop or crashes it, the driver and passengers continue at the same speed the car was going before it stopped. A seatbelt applies an opposing force to the driver and passengers to prevent them from falling out or making contact with the interior of the car. Seatbelts are considered Primary Restraint Systems (PRS), because of their vital role in occupant safety.

One analysis conducted in the United States compared a variety of seat belt types alone and in combination with air bags. The range of fatality reduction for front seat passengers was broad, from 20% to 55%, as was the range of major injury, from 25% to 60%. More recently, the Centers for Disease Control and Prevention has summarized this data by stating “seat belts reduce serious crash-related injuries and deaths by about half.” Most seatbelt malfunctions are a result of there being too much slack in the seatbelt at the time of the accident.

Currently, the only alert for not properly wearing a seat belt is a chime or dashboard lit icon. There has been legislation passed which requires seat belts to be worn when in a car. Police are on the lookout for those not wearing seat belts which provides an impetus to wear seat belts but can only really be determined when a traffic stop or accident has already occurred. Therefore, there is a need to provide notification outside of the vehicle for law enforcement to determine at least one seat belt is not being worn in a car.

### BRIEF DESCRIPTION OF THE DRAWINGS

FIG. 1 is an illustrated view of a vehicle with an exemplary system.

FIG. 2 is an illustrated view of a seat belt for the exemplary system shown in FIG. 1.

### DETAILED DESCRIPTION

The phrases “in one embodiment,” “in various embodiments,” “in some embodiments,” and the like are used repeatedly. Such phrases do not necessarily refer to the same embodiment. The terms “comprising,” “having,” and “including” are synonymous, unless the context dictates otherwise. Such terms do not generally signify a closed list.

“Above,” “adhesive,” “affixing,” “any,” “around,” “both,” “bottom,” “by,” “comprising,” “consistent,” “customized,” “enclosing,” “friction,” “in,” “labeled,” “lower,” “magnetic,” “marked,” “new,” “nominal,” “not,” “of,” “other,” “outside,” “outwardly,” “particular,” “permanently,” “preventing,” “raised,” “respectively,” “reversibly,” “round,” “square,” “substantial,” “supporting,” “surrounded,” “surrounding,” “threaded,” “to,” “top,” “using,” “wherein,” “with,” or other such descriptors herein are used in their normal yes-or-no sense, not as terms of degree, unless context dictates otherwise.

Reference is now made in detail to the description of the embodiments as illustrated in the drawings. While embodiments are described in connection with the drawings and related descriptions, there is no intent to limit the scope to the embodiments disclosed herein. On the contrary, the intent is to cover all alternatives, modifications and equivalents. In alternate embodiments, additional devices, or combinations of illustrated devices, may be added to, or combined, without limiting the scope to the embodiments disclosed herein.

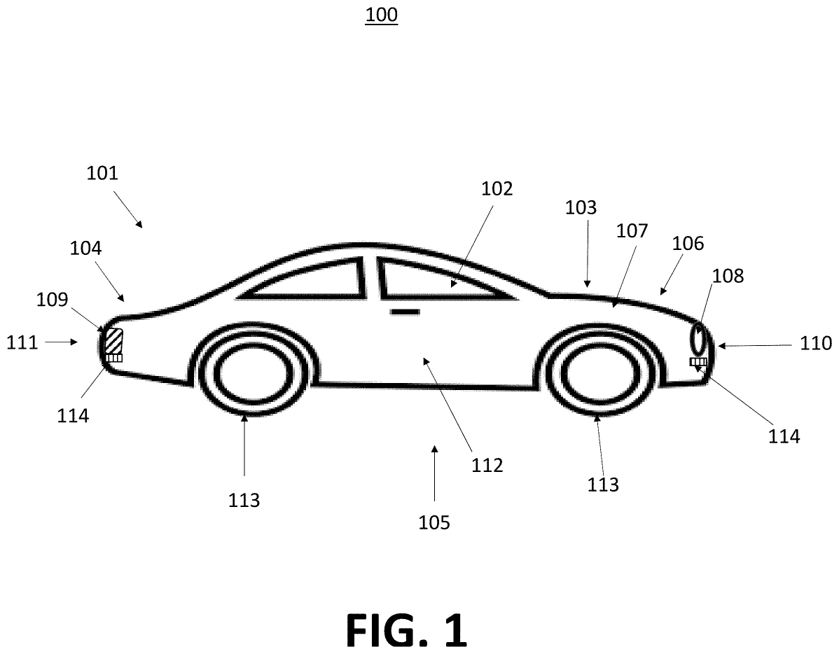

Referring to FIG. 1, is an illustrated view of a vehicle 100 with an exemplary system for providing external notification of seat belt status. The external system is useful for vehicles relating a condition of the seat belt to public safety officials such as police, state troopers, etc. With the external status being visible, the safety of all who are on the road and in the vehicle 100 is enhanced. The external status allows public safety officials to have visible notification to the seat belt status and provides probable cause to remedy the situation.

The vehicle 100 is preferably an automobile, but other vehicles are hereby contemplated including, but not including, semi-trailer trucks, pick-up trucks, sport utility vehicles (SUVs), mini-vans, motorcycles, school bus, trains, etc.

The vehicle 100 has an outside 101 and an inside 102. The vehicle 100 is useful for providing a transportation means for transporting people, pets, etc. from one location to a second desired location.

The inside 102 has one or more seat (not shown) configured to provide a sitting position for the vehicle's passenger and driver. The inside 102 of the vehicle 100 further has a steering wheel (not shown) and a gear shifter (not shown).

The steering wheel is located, in the US, on the left, front side of the inside 102 of the vehicle. The steering wheel is useful for manipulating the direction of the vehicle 100. The gear shifter is useful for manipulating a transmission of the vehicle 100 to put it in a direction, such as reverse, drive or a gear, or for placing the transmission into a parked or neutral condition.

The outside 101 of the vehicle 100 has a front 103, a back 104, two sides 105, a hood 106, an engine 107, front head lights 108 and rear tail lights 109. The hood 106 of the front 103 of the outside 101 of the vehicle 100 is partially removably coupled to the vehicle 100. The engine 107 is configured to be under the hood 106 of the front 102 of the vehicle 100. The hood 106 protects the engine 107 from being subject and/or exposed to elements. The elements may be rain, snow, dirt, grime, smog, etc.

The front head lights 108 are configured at a front portion 110 of the front 102 of the vehicle 100. The front head lights 108 provide lighting, when turned on, to illuminate the road way and provide a view of the road and objects which may be a hinderance or unsafe to drive the vehicle towards.

The rear tail lights 109 are configured at a rear portion 111 of the back 104 of the vehicle 100. The rear tail lights 109 are configured to alert others to left turns, right turns, the transmission being in reverse and parking.

The two sides 105 of the vehicle 100 are generally identical. The two sides 105 of the vehicle have at least one door 112 and one or more wheels 113. The at least one door 112 of each of the two sides 105 of the outside 101 of the vehicle 100 are configured to allow access into and out of the inside 102 of the vehicle 100 for passengers and the driver.

The one or more wheels 113 configured on each of the two sides 105 of the outside 101 vehicle 100 prove ease in movement and transportation of the vehicle 100 and mobilize the vehicle 100 to transport the driver and passengers to a desired location in a fast, easy and generally safe manner.

The vehicle 100 further has one or more exterior seat belt lights 114. The exterior seat belt light 114 is preferably a light emitting diode (LED), but other types of lighting are hereby contemplated including, but not limited to, liquid crystal diode (LCD). Fluorescent, etc.

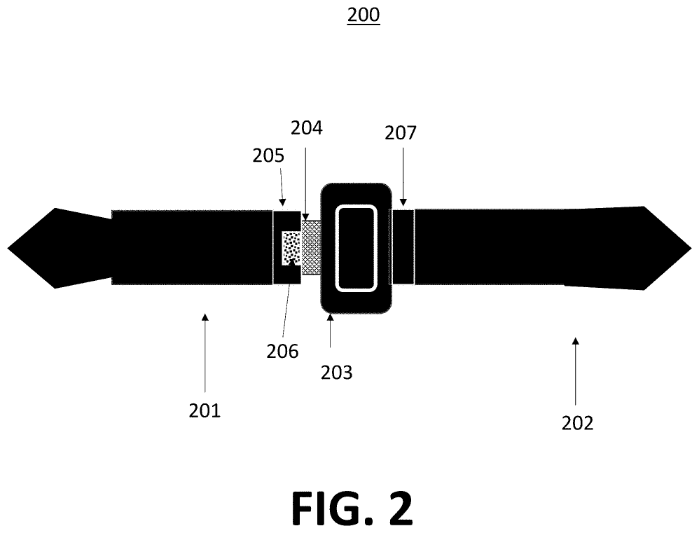

The exterior seat belt lights 114 preferably have a capability to change a color of the seat belt light 114. The color of the seat belt light 114 are preferably red and green, but other colors are hereby contemplated including, but not limited to, yellow, shades of red, etc. The exterior seat belt light 114 may be configured to render the condition of one or more seat belts 200 (See FIG. 2) by illuminating in a color which may be shades of a base color and thus provides knowledge to the public service official as to an individual condition of each of the one or more seat belts 200 configured to be on the inside 102 of the vehicle 100.

The exterior seat belt light 114 is preferably communicatively coupled to the seat belts 200 of the vehicle 100. The exterior seat belt lights 114 preferably utilize Bluetooth® (IEEE 802.15) signaling standards but other communication means are hereby contemplated including, but not limited to, hard wired, IEEE 802.11 (WiFi), 3GPP (4G and/or 5G), etc.

One of the one or more exterior seat belt lights 114 is preferably coupled to the front portion 110 of the front 102 of the outside 101 of the vehicle 100. A second of the one or more exterior seat belt lights 114 is preferably coupled to the rear portion 111 of the back 104 of the outside 101 of the vehicle 100. The one or more exterior seat belt lights 114 may have more than one lamp but may only have one lamp. If the one or more exterior seat belt lights 114 has more than one lamp, then each of the seat belts 200 may be indicated by one of the more than one lamps.

Moving now to FIG. 2, an illustrated view of one of the one or more seat belts 200 for use in the vehicle 100 shown in FIG. 1 is presented.

The one or more seat belts 200 are configured to be in communicative coupling with the one or more exterior seat belt lights 114 of the outside 101 of the vehicle 100. The exterior seat belt lights 114 preferably utilize Bluetooth® (IEEE 802.15) signaling standards but other communication means are hereby contemplated including, but not limited to, hard wired, IEEE 802.11 (WiFi), 3GPP (4G and/or 5G), etc.

The one or more seat belts 200 are securely coupled to the inside 102 of the vehicle 100 and are generally one seat belt per seating position. The seat belts 200 have a first strap 201, a second strap 202, a buckle 204 and a locking clip 205.

The first strap 201 has the locking clip 204 configured on a first end 205 of the first strap 201 of the seat belt 200. The second strap 202 has the buckle 203 configured on a first end 206 of the second strap 202 of the seat belt 200. The buckle 203 securely coupled to the first end 206 of the second strap 202 removably receives the locking clip 204 securely coupled to the first end 205 of the first strap 201.

The first end 201 of the first strap 201 of the seat belt 200 is further configured to have a sensor 206. The sensor 206 detects the current condition of the seat belt 200, that being whether the locking clip 204 is securely coupled to the buckle 205. If the sensor 206 detects the locking clip 204 is securely coupled to the buckle 205, then the sensor 206 sends a signal to the one or more exterior seat belt lights 114 to indicate the condition of the seat belt 200 and the seat belt lights 114 determine the color to illuminate the exterior seat belt lights 114.

In the numbered clauses below, specific combinations of aspects and embodiments are articulated in a shorthand form such that (1) according to respective embodiments, for each instance in which a “component” or other such identifiers appear to be introduced (with “a” or “an,” e.g.) more than once in a given chain of clauses, such designations may either identify the same entity or distinct entities; and (2) what might be called “dependent” clauses below may or may not incorporate, in respective embodiments, the features of “independent” clauses to which they refer or other features described above.

Those skilled in the art will appreciate that the foregoing specific exemplary processes and/or devices and/or technologies are representative of more general processes and/or devices and/or technologies taught elsewhere herein, such as in the claims filed herewith and/or elsewhere in the present application.

The features described with respect to one embodiment may be applied to other embodiments or combined with or interchanged with the features of other embodiments, as appropriate, without departing from the scope of the present invention.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

1. A system for providing external vehicle notification of seat belt status, the system comprising:
one or more seat belts, the seat belt for restraining a passenger in a collision, the seat belt comprising:
a first strap, the first strap having a clip coupled to a first end;
a second strap, the second strap having a buckle coupled to a first end of the second strap, wherein the buckle of the second strap being removably coupled to the clip of the first strap; and
a sensor, the sensor being for detecting the condition of the seat belt, wherein the sensor being coupled to the first end of the first strap; and
one or more lights, the one or more lights being coupled to exterior of a vehicle, and wherein the one or more lights being communicatively coupled to the sensor of the one or more seat belts, wherein the one or more lights being configured to render the condition of one or more seat belts by illuminating in a shade of a base color to render a condition of the one or more seat belts.

2. The system according to claim 1, wherein the one or more lights being light emitting diodes (LEDs).

3. The system according to claim 1, wherein the one or more lights being one or more colors.

4. The system according to claim 3, wherein the one or more colors being red and green.

5. The system according to claim 3, wherein the one or more colors being one or more colors.

6. The system according to claim 1, wherein the sensor being communicatively coupled to the one or more lights being Bluetooth® (IEEE 802.15) signaling.

7. The system according to claim 1, wherein the one or more lights having more than one lamp.

8. The system according to claim 7, wherein each of the one or more seat belts being associated with a different of the one or more lamps.

9. The system according to claim 1, wherein one of the one or more lights being coupled to a front portion of a front of the vehicle.

10. The system according to claim 1, wherein one of the one or more lights being coupled to a rear portion of a back of the vehicle.
